(19) United States
(12) Patent Application Publication
(10) Pub. No.: US 2025/0335038 A1
(43) Pub. Date: Oct. 30, 2025

(54) HAPTIC MEDIA PROCESSING

(71) Applicant: Tencent Technology (Shenzhen) Company Limited, Shenzhen (CN)

(72) Inventor: Ying HU, Shenzhen (CN)

(73) Assignee: Tencent Technology (Shenzhen) Company Limited, Shenzhen, GD (CN)

(21) Appl. No.: 19/263,333

(22) Filed: Jul. 8, 2025

Related U.S. Application Data
(63) Continuation of application No. PCT/CN2024/089006, filed on Apr. 22, 2024.

(30) Foreign Application Priority Data
Apr. 24, 2023 (CN) 202310472353.0

(51) Int. Cl. G06F 3/01; G06T 17/20

(52) U.S. Cl. CPC G06F 3/016; G06T 17/20

(57) ABSTRACT

In a haptic media processing method, an interchange-format file of haptic media content is obtained. The interchange-format file includes a data structure of a haptic channel. The data structure of the haptic channel includes a channel group flag, and the channel group flag indicates whether the haptic channel belongs to a channel group. When the channel group flag indicates that at least two haptic channels belong to the channel group. The haptic channels in the channel group are mixed, to obtain a haptic media signal. Apparatus and non-transitory computer-readable storage medium counterpart embodiments are also contemplated.

### RELATED APPLICATIONS

The present application is a continuation of International Application No. PCT/CN2024/089006, entitled “PROCESSING METHOD AND APPARATUS FOR HAPTIC MEDIA, AND STORAGE MEDIUM, ELECTRONIC DEVICE AND PROGRAM PRODUCT” and filed on Apr. 22, 2024, which claims priority to Chinese Patent Application No. 202310472353.0, entitled “HAPTIC MEDIA PROCESSING METHOD AND APPARATUS, AND ELECTRONIC DEVICE” and filed on Apr. 24, 2023. The entire disclosures of the prior applications are hereby incorporated by reference.

### FIELD OF THE TECHNOLOGY

This application relates to the field of multimedia technologies, including to a haptic media processing method, a haptic media processing apparatus, a computer-readable medium, an electronic device, and a computer program product.

### BACKGROUND OF THE DISCLOSURE

Presentation of immersive media content is usually accompanied with various wearable devices or interactive devices. Therefore, in terms of a manner for presenting immersive media, in addition to conventional visual and auditory presentation, the immersive media further has a new presentation manner such as haptic presentation.

For a haptic media signal corresponding to one haptic experience, in some examples, the haptic media signal can be stored, rendered, and presented in only one data unit, causing poor processing flexibility.

### SUMMARY

This disclosure provides a haptic media processing method, a haptic media processing apparatus, a computer-readable medium, an electronic device, and a computer program product, to improve processing flexibility of haptic media content.

According to an aspect of the embodiments of this disclosure, a haptic media processing method is provided. In the haptic media processing method, an interchange-format file of haptic media content is obtained. The interchange-format file includes a data structure of a haptic channel. The data structure of the haptic channel includes a channel group flag, and the channel group flag indicates whether the haptic channel belongs to a channel group. When the channel group flag indicates that at least two haptic channels belong to the channel group. The haptic channels in the channel group are mixed, to obtain a haptic media signal.

According to an aspect of the embodiments of this disclosure, a haptic media processing method is provided. In the haptic media processing method, a to-be-encoded haptic media signal is decomposed into at least two haptic channels belonging to a same channel group. A data structure of the haptic channel includes a channel group flag. The channel group flag indicates whether the haptic channel belongs to the channel group. Based on at least one of the haptic channels, an interchange-format file of haptic media content is generated.

According to an aspect of the embodiments of this disclosure, a haptic media processing apparatus including processing circuitry is provided. The processing circuitry is configured to obtain an interchange-format file of haptic media content. The interchange-format file includes a data structure of a haptic channel. The data structure of the haptic channel includes a channel group flag. The channel group flag indicates whether the haptic channel belongs to a channel group. When the channel group flag indicates that at least two haptic channels belong to the channel group, the processing circuitry is configured to mix the haptic channels in the channel group, to obtain a haptic media signal.

According to an aspect of the embodiments of this disclosure, a haptic media processing method is provided. The method includes: obtaining an interchange-format file configured for representing haptic media content, the interchange-format file including at least one haptic channel, a data structure of the haptic channel at least including a channel group flag field, and the channel group flag field being configured for indicating whether the haptic channel belongs to a channel group; and when the channel group flag field indicates that at least two haptic channels belong to the channel group, mixing all haptic channels in the channel group, to obtain a to-be-rendered haptic media signal.

According to an aspect of the embodiments of this disclosure, a haptic media processing method is provided. The method includes: decomposing a to-be-encoded haptic media signal into at least two haptic channels belonging to the same channel group, a data structure of the haptic channel at least including a channel group flag field, and the channel group flag field being configured for indicating whether the haptic channel belongs to the channel group; and generating, based on at least one of the haptic channels, an interchange-format file configured for representing haptic media content.

According to an aspect of the embodiments of this disclosure, a haptic media processing apparatus is provided. The apparatus includes: an obtaining module, configured to obtain an interchange-format file configured for representing haptic media content, the interchange-format file including at least one haptic channel, a data structure of the haptic channel at least including a channel group flag field, and the channel group flag field being configured for indicating whether the haptic channel belongs to a channel group; and a mixing module, configured to: when the channel group flag field indicates that at least two haptic channels belong to the channel group, mix all haptic channels in the channel group, to obtain a to-be-rendered haptic media signal.

According to an aspect of the embodiments of this disclosure, a haptic media processing apparatus is provided. The apparatus includes: a decomposition module, configured to decompose a to-be-encoded haptic media signal into at least two haptic channels belonging to the same channel group, a data structure of the haptic channel at least including a channel group flag field, and the channel group flag field being configured for indicating whether the haptic channel belongs to the channel group; and a generation module, configured to generate, based on at least one of the haptic channels, an interchange-format file configured for representing haptic media content.

According to an aspect of the embodiments of this disclosure, a computer-readable medium, such as a non-transitory computer-readable storage medium, is provided, having a computer program stored therein, the computer program, when executed by a processor, implementing the haptic media processing method in the foregoing technical solutions.

According to an aspect of the embodiments of this disclosure, an electronic device is provided, the electronic device including: a processor; and a memory, configured to store executable instructions of the processor, the processor being configured to execute the executable instructions to implement the haptic media processing method in the foregoing technical solutions.

According to an aspect of the embodiments of this disclosure, a computer program product is provided, including a computer program, the computer program, when executed by a processor, implementing the haptic media processing method in the foregoing technical solutions.

### BRIEF DESCRIPTION OF THE DRAWINGS

FIG. 1 is a schematic flowchart of encoding and decoding haptic media in an application scenario according to an embodiment of this disclosure.

FIG. 2 illustrates a system architecture in an application scenario according to an embodiment of this disclosure.

FIG. 3 is a flowchart of a haptic media processing method on a decoder side according to an embodiment of this disclosure.

FIG. 4 illustrates a data structure of an interchange-format file configured for representing haptic media content according to an embodiment of this disclosure.

FIG. 5 is a flowchart of a haptic media processing method on an encoder side according to an embodiment of this disclosure.

FIG. 6 is a schematic diagram of data structures of a plurality of haptic channels represented based on a channel group in an application scenario according to an embodiment of this disclosure.

FIG. 7 is a schematic structural block diagram of a haptic media processing apparatus on a decoder side according to an embodiment of this disclosure.

FIG. 8 is a schematic structural block diagram of a haptic media processing apparatus on an encoder side according to an embodiment of this disclosure.

FIG. 9 is a schematic structural block diagram of a computer system adapted to implement an electronic device according to an embodiment of this disclosure.

### DESCRIPTION OF EMBODIMENTS

Examples of implementations are described more comprehensively with reference to the accompanying drawings. However, the implementations can be implemented in various forms, and should not be construed as being limited to the examples described herein. Other embodiments are within the scope of this disclosure.

In addition, the described features, structures, or characteristics may be combined in one or more embodiments. In the following descriptions, examples of specific details are provided to provide a more comprehensive understanding of the embodiments of this disclosure. However, a person skilled in the art is to be aware that, the technical solutions in this disclosure may be implemented without one or more of the specific details, or another method, unit, apparatus, or step may be used.

The block diagrams shown in the accompanying drawings are merely functional entities and do not necessarily correspond to physically independent entities. In other words, these functional entities may be implemented in a form of software, or implemented in at least one hardware module or integrated circuit, or implemented in different networks and/or processor apparatuses and/or microcontroller apparatuses.

The flowcharts shown in the accompanying drawings are merely examples for descriptions, do not necessarily include all content and operations/steps, and are not necessarily performed in the described orders either. For example, some operations/steps may be further divided, while some operations/steps may be combined or partially combined. Therefore, an actual execution order may change according to an actual case.

Examples of terms involved in the aspects of the disclosure are briefly introduced. The descriptions of the terms are provided as examples only and are not intended to limit the scope of the disclosure.

In this embodiment of this disclosure, immersive media is media content that can provide an immersive experience for a consumer, so that the consumer immersed in the media content can obtain sensory experience such as visual experience and auditory experience in the real world. The immersive media may be classified into three degrees of freedom (3DoF) media, three degrees of freedom plus (3DoF+) media, and six degrees of freedom (6DoF) media based on a degree of freedom (DoF) of the consumer when consuming media content. The 3DoF media may support the user to consume corresponding media content by using the 3DoF, the 3DoF+ media may support the user to consume corresponding media content by using the 3DoF+, and the 6DoF media may support the user to consume corresponding media content by using the 6DoF.

The 3DoF is three degrees of freedom that a user is fixed at a central point of three-dimensional space, and the head of the user may rotate around an X axis, a Y axis, and a Z axis.

The 3DoF+ is a degree of freedom that the head of the user may further perform limited motion (e.g., translation in limited space) along the X axis, the Y axis, and the Z axis based on the three degrees of freedom.

The 6DoF is a degree of freedom that the consumer may further freely move (e.g., freely translate) along the X axis, the Y axis, and the Z axis based on the three degrees of freedom.

The degree of freedom mentioned in this embodiment of this disclosure may be understood as a degree of freedom supporting motion of the user and generating content interaction when the user watches the immersive media.

In terms of a presentation manner, immersive media further has a new presentation manner, namely, haptic presentation in addition to visual and auditory presentation.

Haptics is sense experience, such as vibration, pressure, and temperature, obtained by a human body through contact.

Through a haptic presentation mechanism combining hardware and software, the haptic presentation allows a user to receive information by using a body part, provides an embedded physical feeling, and transfers key information of a system being used by the user. For example, a mobile phone vibrates to remind an owner of the mobile phone that a piece of information is received. Such vibration is a type of haptic presentation. The haptic presentation may enhance auditory and visual presentation, to improve user experience.

A haptic media signal is configured for representing haptic experience in a specific modality, and is a signal rendered and presented on a specific haptic device.

The haptic presentation may be classified into a plurality of categories such as vibro-haptics, kinesthetic haptics, and electro-haptics.

The vibro-haptics means directly performing the haptic presentation in a form of vibration. The vibro-haptics may simulate vibration at a specific frequency and intensity through vibration of a motor of a terminal device. For example, in a shooting game, a particular effect during use of a shooting prop is simulated through vibration.

The kinesthetic haptics is configured for simulating a movement state such as a weight or pressure of an object. For example, in a game related to vehicle driving, such as an automobile, during movement at a high speed or operation of a heavy vehicle, a steering wheel may resist rotation. Such feedback directly affects muscles of the user. In an example of a driving game, the user needs to apply more force to obtain a needed response from the steering wheel.

The electro-haptics is feedback information for simulating a specific texture by means of electrical stimulation. The electro-haptics presentation uses electric impulses to provide haptic stimulation to nerve endings on the skin of the user. The electro-haptics presentation may create highly realistic experience for the user wearing a suit or a glove provided with an electro-haptics technology. Almost any feeling may be simulated by using an electric impulse, such as a temperature change, a pressure change, and a sense of humidity.

The haptic presentation has been a presentation manner accustomed to by users, from device vibro-haptics commonly applied daily to diversified haptic presentation in subdivided fields. With the popularization of wearable devices and interactive devices, the haptic presentation perceptible to a user when consuming media content is no longer limited to basic vibro-haptics, but includes haptic presentation experience that is more approximate to the real world with a comprehensive motion sensing, such as vibration, pressure, speed, acceleration, temperature, humidity, and smell.

An embodiment of this disclosure provides a haptic media content processing method, which may be configured for flexibly processing a haptic media signal and supporting storage and transmission of a bitstream of haptic media based on representation of the haptic media signal. This embodiment of this disclosure may be specifically applied to related products involving haptic feedback, for example, links such as a server end, a player end, and an intermediate node of an immersive system.

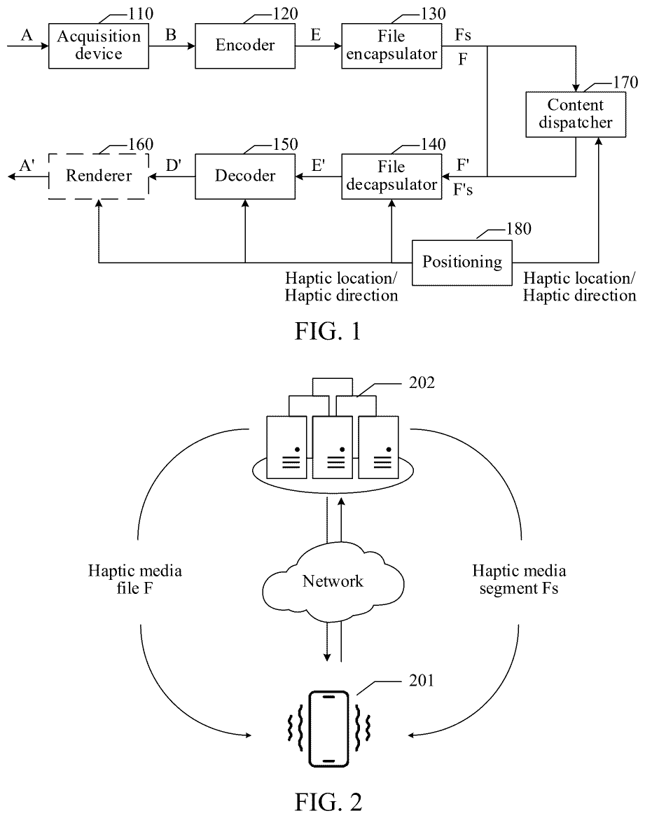

FIG. 1 is a schematic flowchart of encoding and decoding haptic media in an application scenario according to an embodiment of this disclosure.

As shown in FIG. 1, a haptic media signal A is acquired (or generated, which is not shown in the figure) through an acquisition device 110, so that description information of the haptic media signal such as an amplitude, a frequency, and time is obtained. The acquisition device 110 may be a sensor device configured to acquire a real haptic signal from the real world, or may be a computer device that generates a virtual haptic signal by simulating a haptic effect by using software.

The acquisition device 110 generates an interchange-format file B based on the haptic media signal A, and the interchange-format file B is a file that includes a large quantity of haptic media signals and that has a specified interchange format. At least one interchange-format file B may be encoded through an encoder 120, to obtain an encoded haptic media bitstream E.

A file encapsulator 130 may encapsulate at least one haptic media bitstream E based on a specific file format, to obtain a haptic media file F configured for generating a haptic effect or a series of initialized segments (not shown in the figure) and a haptic media segment Fs configured for streaming transmission.

The media file F output by the file encapsulator 130 is identified as a media file F′ when the media file F is received by a file decapsulator 140. The haptic media segment Fs output by the file encapsulator 130 is identified as a haptic media segment F's when the haptic media segment Fs is received by the file decapsulator 140.

The file decapsulator 140 may extract a haptic media bitstream E′ by processing the media file F′ received or processing the media segment F's received, and parse metadata.

A decoder 150 may decode the haptic media bitstream E′ into a decoding signal, and generate haptic media data D′ based on the decoding signal.

Various types of haptic devices may determine a haptic location or a haptic direction where a haptic effect is currently generated. As shown in FIG. 1, a positioning module 180 determines a current haptic location or haptic direction, and may send the current haptic location or haptic direction to the file decapsulator 140, the decoder 150, a renderer 160, and a content dispatcher 170.

The renderer 160 may render the haptic media data D′ based on the current haptic location or haptic direction to obtain a haptic media signal A′, and display (or otherwise output) the haptic media signal A′ on the haptic device.

In this embodiment of this disclosure, the current haptic location or haptic direction may further be used by the decoder 150 for performing decoding optimization.

In the content dispatcher 170, the current haptic location and haptic direction are also transferred to a policy module (not shown in the figure), where the policy module may be configured to determine a to-be-received haptic channel.

In a haptic media transmission technology, media resource transmission between a server and a client is usually processed by using a streaming transmission technology. Common media streaming transmission technologies include technologies such as dynamic adaptive streaming over HTTP (DASH), HTTP live streaming (HLS), and smart media transport (SMT).

Using DASH as an example, DASH is an adaptive bitrate streaming technology, enabling high-quality streaming media to be transferred via the Internet through a conventional hyper text transfer protocol (HTTP) network server. DASH splits content into a series of small HTTP-based file segments. Each segment includes very short playable content, and a total length of the content may be several hours (e.g., a movie or a live broadcast of a sports event). The content is made into alternative segments with a plurality of bitrates, to provide versions with the plurality of bitrates for selection. When the media content is played by a DASH client, the client automatically selects, based on a current network condition, a specific alternative solution for downloading and play. The client selects a segment with a highest bitrate that can be downloaded in time, and plays the segment, to avoid events such as play frame freezing or re-buffering. In this way, the DASH client can seamlessly adapt to constantly changing network conditions and provide high-quality playback experience, with less frame freezing and a reduced rate of occurrence of re-buffering.

Smart media transport (SMT) is an intelligent media transmission standard, and specifies an intelligent media transmission technology that covers an encapsulation format, a transmission protocol, and a signaling message, to be applied to transmission and sending of multimedia data in a heterogeneous packet-switched network.

FIG. 2 illustrates a system architecture in an application scenario according to an embodiment of this disclosure. As shown in FIG. 2, the system architecture may include a client 201 and a server 202.

The client 201 may include various electronic devices such as a smartphone, a tablet computer, a notebook computer, a desktop computer, a smart speaker, an intelligent wearable device, an intelligent in-vehicle device, and an intelligent payment terminal, and may particularly include a wearable device or an interactive device that can render a haptic effect.

The server 202 may be an independent physical server, or may be a server cluster including a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

The client 201 and the server 202 are connected via a network. The network may be a communication medium of a connection type that can provide a communication link between the client 201 and the server 202, for example, may provide a wired communication link or a wireless communication link.

According to an implementation requirement, the system architecture in this embodiment of this disclosure may have any quantity of clients and servers. For example, the server 202 may be a server cluster including a plurality of server devices.

In addition, the technical solutions provided in this embodiment of this disclosure may be applied to the client 201, or may be applied to the server 202, or may be jointly implemented by the client 201 and the server 202. This is not specifically limited in this disclosure.

For example, a haptic media processing method in this embodiment of this disclosure may include the following processes.
(1) The server 202 produces or acquires a haptic media signal based on an expected haptic media effect, and generates an interchange-format file of the haptic media signal, specifically including information such as basic metadata, a display device, and a displayed character of haptic media.
(2) The server 202 compresses the haptic media signal into a haptic media bitstream.
(3) The server 202 encapsulates the haptic media bitstream into a haptic media file, and transmits the haptic media file to the client 201 of a user.

In this embodiment of this disclosure, the server 202 may directly transmit a complete haptic media file F to the client 201.

Alternatively, the server 202 may transmit at least one haptic media segment Fs to the client 201 through streaming transmission. During the streaming transmission, the server 202 sends a signaling message for describing a media resource to the client 201, and the client 201 requests a specific media resource based on the signaling message. The signaling message may be, for example, media presentation description (MPD) signaling in DASH, configured for describing media segment information.

(4) The client 201 receives the haptic media file F or the haptic media segment Fs, obtains a haptic media signal through decapsulation and decoding, renders the haptic media signal, and displays the haptic media signal to the user.

Technical solutions such as a haptic media processing method, a haptic media processing apparatus, a computer-readable medium, an electronic device, and a computer program product provided in this disclosure are described in detail below with reference to specific implementations.

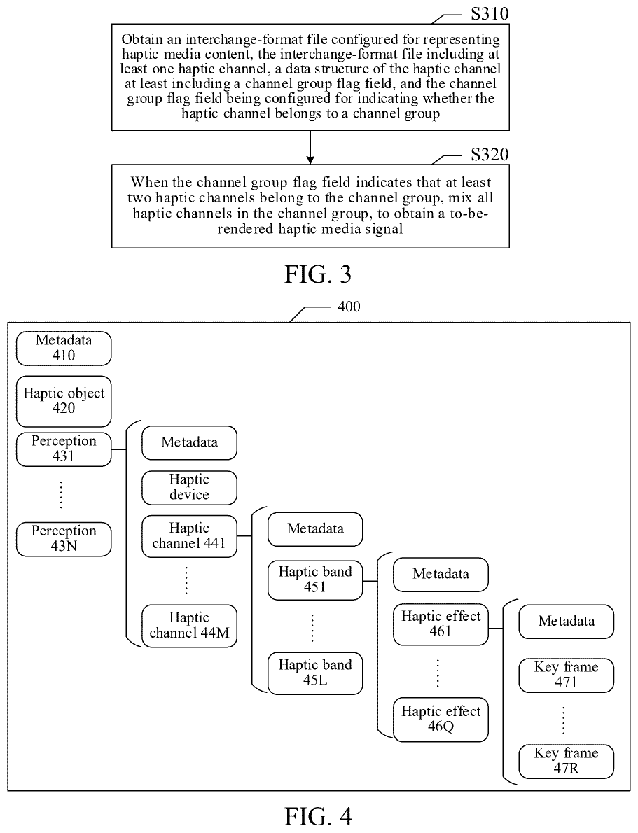

FIG. 3 is a flowchart of a haptic media processing method on a decoder side according to an embodiment of this disclosure. The haptic media processing method may be performed by the client or the server shown in FIG. 2. This embodiment of this disclosure is described by using an example in which the method is performed by the client. As shown in FIG. 3, the haptic media processing method may include the following operations S310 and S320.

S310: Obtain an interchange-format file configured for representing haptic media content, the interchange-format file including at least one haptic channel, a data structure of the haptic channel at least including a channel group flag field, and the channel group flag field being configured for indicating whether the haptic channel belongs to a channel group. In an example, an interchange-format file of haptic media content is obtained. The interchange-format file includes a data structure of a haptic channel. The data structure of the haptic channel includes a channel group flag, and the channel group flag indicates whether the haptic channel belongs to a channel group.

The haptic media content is media content that is in immersive media content and that is presented in a haptic manner. The interchange-format file is a format file configured for data transmission and exchange between a server end and a client. A data exchange format of the interchange-format file may include, for example, extensible markup language (XML) or a text data exchange format javascript object notation (JSON).

Javascript object notation (JSON) is a lightweight data exchange format. JSON stores and represents data in a text format completely independent from a programming language. A simple and clear hierarchical structure makes JSON an ideal data exchange language. This is easy for people to read and write and is easy for machine parsing and generation, and effectively improves network transmission efficiency.

S320: When the channel group flag field indicates that at least two haptic channels belong to the channel group, mix all haptic channels in the channel group, to obtain a to-be-rendered haptic media signal. In an example, when the channel group flag indicates that at least two haptic channels belong to the channel group. The haptic channels in the channel group are mixed, to obtain a haptic media signal.

In this embodiment of this disclosure, for haptic media signals of the same perceptual type, the haptic media signals may be encoded on a plurality of haptic channels. The haptic channel is configured for defining signals corresponding to different body parts and/or different rendering devices.

In an example, the haptic channel is configured for defining a signal rendered on a specific body part. In this case, a type of the signal is related to the body part.

In another example, the haptic channel is configured for defining a signal rendered by using a dedicated rendering device. In this case, a type of the signal is related to a type of the rendering device. The dedicated rendering device is, for example, an actuator, a sensor, or another device that can perform rendering.

In still another example, the haptic channel is configured for defining a signal rendered on a specific body part by using a dedicated rendering device. In this case, a type of the signal is related to both the body part and a type of the rendering device.

In this embodiment of this disclosure, mixing signals of all the haptic channels in the same channel group means performing weighted superposition on the signals, to obtain the to-be-rendered haptic media signal.

Metadata stored at a level of the haptic channel includes information such as a gain, a mixing weight, an expected body part for haptic feedback, and an exemplary reference device and/or haptic direction associated with the channel. In addition, additional information such as an expected sampling frequency or sampling count may be further provided.

In the haptic media processing method provided in this embodiment of this disclosure, the interchange-format file configured for representing the haptic media content includes at least one haptic channel. When at least two haptic channels form a channel group, all haptic channels in the channel group may be mixed to obtain a to-be-decoded haptic media signal. In this way, one haptic media signal is dispersed into a plurality of haptic channels, and each haptic channel may be restricted by using the channel group. In processing sections such as encoding, encapsulation, decapsulation, decoding, and rendering of the haptic media content, data may be processed based on a single haptic channel, or data may be processed based on a channel group, so that flexibility of haptic media processing is improved.

FIG. 4 illustrates a data structure of an interchange-format file 400 configured for representing haptic media content according to an embodiment of this disclosure. As shown in FIG. 4, an interchange-format file 400 may include metadata 410, a haptic object (avatar) 420, and N types of perception 431, . . . , and 43N. The haptic object represents a user object feeling a haptic effect. The perception represents various different haptic types, for example, different types of vibro-haptics, kinesthetic haptics, electro-haptics, or the like.

The haptic media signals of the same perceptual type may be represented as different haptic channels based on different sensors or rendering devices on which the haptic media signals are finally presented. Based on this, haptic media signals presented on the same haptic device may be represented as M different haptic channels 441 . . . 44M. In this case, the M different haptic channels need to be mixed into one haptic media signal and then presented.

Haptic data of a single haptic channel may be included in a group of haptic bands that are defined based on a frequency range of the haptic channel, for example, L haptic bands 451 . . . , and 45L.

Each haptic band may be further decomposed into Q haptic effects 461 . . . , and 46Q.

Each haptic effect may be further decomposed into R key frames 471 . . . , and 47R.

N, M, L, Q, and R are positive integers.

In an embodiment of this disclosure, a data structure of a haptic channel includes at least one attribute field related to a channel group, where the attribute field is configured for representing whether the haptic channel belongs to a haptic channel group, or is configured for representing an identifier of a channel group to which the haptic channel belongs.

In an embodiment of this disclosure, a data structure of a haptic channel includes a channel group flag field channel_group_flag, and the field is configured for indicating whether the haptic channel belongs to a channel group. For example, a default value of the channel group flag field may be “false”, it indicates that the current haptic channel does not belong to any channel group; and when the value of the channel group flag field is “true”, it indicates that the current haptic channel belongs to a channel group.

In an embodiment of this disclosure, when a haptic channel belongs to a channel group, a data structure of the haptic channel further includes a channel group identifier field channel_group_id, configured for indicating an identifier of the channel group to which the haptic channel belongs. Weighted mixing is performed on signals corresponding to all haptic channels in the channel group, to obtain a signal that needs to be finally rendered. The haptic channels belonging to the same channel group are to have the same channel group identifier, and haptic channels belonging to different channel groups are to have different channel group identifiers. When a value of the channel group flag field is “true”, the channel group identifier field may be a mandatory field.

In this embodiment of this disclosure, a combination of the channel group flag field and the channel group identifier field is configured for defining the data related to the channel group. However, in some other implementations, the channel group flag field may not be used, and only the channel group identifier field is configured for defining the data related to the channel group.

In an embodiment of this disclosure, a data structure of a haptic channel includes a channel group flag field. The field is configured for indicating whether the haptic channel belongs to a channel group and may further be configured for indicating an identifier of a channel group when the haptic channel belongs to the channel group.

In an embodiment of this disclosure, if a value of the channel group flag field is a preset first value, it indicates that the haptic channel does not belong to any channel group; or if a value of the channel group flag field is a second value different from a first value, it indicates that the haptic channel belongs to a channel group, and the identifier of the channel group is determined based on the second value.

For example, when a value of the channel group flag field is 0, it indicates that the current haptic channel does not belong to any channel group; or when a value of the field is a non-O value, the field indicates that the current haptic channel belongs to a channel group, and the value of the field is an identifier of the channel group to which the current haptic channel belongs. Channels belonging to the same channel group are to have the same channel group identifier (not 0), and channels belonging to different channel groups are to have different channel group identifiers (not 0).

In an embodiment of this disclosure, when a haptic channel belongs to a channel group, a data structure of the haptic channel may further include a mixing weight field mixing_weight, configured for indicating a weight used when all haptic channels in the channel group are mixed to obtain a haptic media signal.

In an embodiment of this disclosure, when a haptic channel does not belong to any channel group, a data structure of the haptic channel may further include a body part mask field body_part_mask, configured for indicating a body part rendered based on the haptic channel.

For example, the body part mask field body_part_mask may be a binary mask, configured for specifying a location of a rendering effect on a body. A binary mask 0x0 represents that no body part is specified, and an application may render an effect anywhere. A binary mask 0xFFFFFFFF corresponds to an entire body, which means that the effect is applied to the entire body. For example, the binary mask may be configured for explosion and impact or another background effect.

In an embodiment of this disclosure, a plurality of haptic channels belonging to the same channel group may share a part of metadata fields, to avoid a problem of repeated indication of metadata on the plurality of haptic channels, and overcome a defect of data redundancy.

In this embodiment of this disclosure, types of the haptic channels belonging to the same channel group may include, for example, a basic type and a non-basic type. If the haptic channel is of the basic type, a data structure of the haptic channel further includes at least one metadata field related to a rendering device or a rendered part; or if the haptic channel is of the non-basic type, a data structure of the haptic channel does not include a metadata field related to a rendering device or a rendered part. The rendered part is a rendered body part.

In an embodiment of this disclosure, a data structure of a haptic channel may further include a metadata information flag field, configured for indicating whether the haptic channel includes metadata information related to a rendering device or a rendered part. A type of the haptic channel may be determined as a basic type or a non-basic type based on the metadata information flag field.

In this embodiment of this disclosure, whether the current haptic channel includes the metadata information related to the rendering device or the rendered part may be determined based on different values of the metadata information flag field, in other words, the different values of the metadata information flag field is used to determine that the type of the current haptic channel is the basic type or the non-basic type.

For example, when a value of a metadata information flag field in a haptic channel is a preset first value (e.g., a value of 1), it indicates that the haptic channel is of a basic type in a channel group, and the haptic channel includes the metadata information related to the rendering device or the rendered part; or when a value of a metadata information flag field in a haptic channel is a preset second value (e.g., a value of 2), it indicates that the haptic channel is of a non-basic type in a channel group, and the haptic channel does not include the metadata information related to the rendering device or the rendered part.

In an embodiment of this disclosure, a data structure of a haptic channel further includes a channel identifier field, configured for indicating an identifier of the haptic channel; and a type of the haptic channel may be determined based on a value of the channel identifier field.

In some implementations, the basic type is a type of a haptic channel that is in the channel group and that corresponds to a channel identifier field having a smallest value.

In some implementations, the metadata field related to the rendering device or the rendered part may include a body part mask field, configured for indicating a body part rendered based on a haptic channel.

In some implementations, the metadata field related to the rendering device or the rendered part may further include at least one of the following plurality of fields:
reference device identifier field reference_device_id, configured for indicating an identifier of the rendering device corresponding to the haptic channel;
device resolution field actuator_resolution, configured for indicating a resolution of the rendering device corresponding to the haptic channel, where the device resolution field and related fields such as a body part target field and a device target field may be jointly used as a spatialized model of experience of the haptic object;
body part target field body_part_target, configured for indicating a semantic descriptor of a body part or a group of body parts rendered based on the haptic channel;
device target field actuator_target, configured for indicating location information of the rendering device corresponding to the haptic channel;
vertex field vertices, configured for indicating a mesh vertex of a haptic object corresponding to the haptic channel, where the vertex field is located in an index list of the mesh vertex associated with a perceived haptic object, and if the haptic object does not specify a mesh, this field is to be ignored; and the vertex affected by the haptic channel effect is a subject position to which the haptic effect is applied; and
direction field direction, configured for indicating a haptic direction based on which a signal of the haptic channel is rendered, where the haptic direction is a presentation direction for identifying spatialized haptic experience. The direction is related to a relative location of the body part in a coordinate system of the body part. The haptic direction is configured for specifying presentation of a haptic effect in a predetermined direction.

Spatialization of haptic stimulation associated with the haptic channel on the body may be specified in a plurality of manners below. A set of vertexes (having vertex properties) is referenced from a customized mesh. Alternatively, a body part mask may be used to indicate a plurality of defined body segmentation parts. Alternatively, semantics mapped from the body parts and the haptic devices corresponding to the body parts are combined for identification. These spatialization manners may be used in a combination.

In an application scenario according to this embodiment of this disclosure, description information of attribute fields forming a data channel is shown in Table 1 below.

TABLE 1

| | | Default | | Whether it |
|---|---|---|---|---|
| Attribute | Data type | value | Description | is necessary |
| id | integer | None | Channel identifier, whose value needs | Yes |
| | | | to be greater than or equal to 0 | |
| description | string | None | Channel description character string | Yes |
| reference_device_id | integer | None | Identifier of a rendering device | No |
| | | | corresponding to a current channel, | |
| | | | where corresponding device | |
| | | | information is defined in an | |
| | | | MPEG_haptics.perception element | |
| gain | number | None | Gain of a current channel | Yes |
| channel_group_flag | bool | False | Whether a current channel belongs to | Yes |
| | | | a channel group | |
| channel_group_id | integer | None | Indicate an identifier of a channel | Conditional |
| | | | group to which a current channel | |
| | | | belongs, where weighted mixing is | |
| | | | performed on all channels in the | |
| | | | channel group to obtain a signal that | |
| | | | needs to be finally rendered. | |
| | | | Channels belonging to the same | |
| | | | channel group are to have the same | |
| | | | channel group identifier, and channels | |
| | | | belonging to different channel groups | |
| | | | are to have different channel group | |
| | | | identifiers. When a value of | |
| | | | channel_group_flag is “true”, the | |
| | | | field is a mandatory field. | |
| mixing_weight | number | None | If a current channel belongs to a | Conditional |
| | | | channel group, the field is a | |
| | | | mandatory field, and indicates a | |
| | | | weight of the current channel in the | |
| | | | corresponding channel group. | |
| body_part_mask | integer | 0 | Binary mask, configured for | Conditional |
| | | | indicating a body part rendered based | |
| | | | on a current channel. A value of the | |
| | | | field needs to be greater than or equal | |
| | | | to 0. The field is a mandatory field | |
| | | | only in the following cases: | |
| | | | 1. The value of channel_group_flag is | |
| | | | “false”. | |
| | | | 2. The value of channel_group_flag is | |
| | | | “true” and the current channel is a | |
| | | | channel having a smallest id in a | |
| | | | channel group to which the current | |
| | | | channel belongs. | |
| | | | If the current channel does not satisfy | |
| | | | the foregoing conditions, the field | |
| | | | does is not to exist. | |
| actuator_resolution | MPEG_haptic_{—} | None | Resolution of a sensor or renderer | No |
| | vector | | corresponding to a current channel | |
| body_part_target | array<string> | None | Semantic descriptor of a body part or | No |
| | | | a group of body parts | |
| actuator_target | array<MPEG_{—} | None | Information about a target sensor or | No |
| | haptics.vector> | | renderer corresponding to a current | |
| | | | channel, defined by using coordinates | |
| frequency_sampling | integer | None | Sampling frequency of an original | No |
| | | | signal, where if the field exists, the | |
| | | | value of the field is to be greater than | |
| | | | or equal to 0 | |
| sample_count | integer | None | Sample quantity of original signals, | No |
| | | | where if the field exists, the value of | |
| | | | the field is to be greater than or equal | |
| | | | to 0 | |
| vertices | array<integer> | None | Index number of a vertex of a haptic | No |
| | | | object (character) corresponding to a | |
| | | | current channel, where a | |
| | | | corresponding character identifier is | |
| | | | indicated in an | |
| | | | MPEG_haptics.perception element | |
| bands | array<MPEG_{—} | None | List of haptic bands forming a current | Yes |
| | haptics.band> | | channel, where one channel may | |
| | | | include at least one band, and if a | |
| | | | band array is null, the current channel | |
| | | | does not include haptic media signal | |
| | | | data | |
| direction | MPEG_{—} | N/A | Spatial direction of a current channel, | No |
| | haptic.vector | | where the attribute only appears in a | |
| | | | haptic modality that relies on spatial | |
| | | | information (e.g., stiffness, a vibro- | |
| | | | haptic texture, and a coefficient of | |
| | | | friction). | |

In the application scenario, when there is a channel group in an interchange-format file, the following example metadata information is used to indicate only a haptic channel that is in the channel group and whose identifier has a smallest value is indicated, and may not be repeatedly indicated in metadata of another haptic channels in the channel group, where the metadata information includes: reference_device_id, actuator_resolution, body_part_target, actuator_target, vertices, and direction.

In an embodiment of this disclosure, a method for obtaining an interchange-format file configured for representing haptic media content may include: obtaining a haptic media bitstream, the haptic media bitstream including haptic channel metadata configured for decoding a haptic channel, and the haptic channel metadata including a field related to a channel group, and at least including the channel group flag field; and decoding the haptic media bitstream, to obtain the interchange-format file configured for representing the haptic media content.

In an embodiment of this disclosure, the haptic channel metadata further includes a metadata information flag field metadata_info_flag, where the field is configured for indicating whether the haptic channel includes metadata information related to a rendering device or a rendered part.

The haptic media bitstream may be, for example, a binary bitstream obtained by converting the interchange-format file. In an application scenario of this embodiment of this disclosure, MPEG_haptics_channel is configured for representing a data structure representing the channel metadata in the binary bitstream. Syntactic and semantic content included in the data structure is shown in Table 2 below.

TABLE 2

| Syntax | Quantity of bits | Description |
|---|---|---|
| MPEG_haptics_channel ( ) | | |
| { | | |
| id; | 8 | uimsbf |
| descriptionStringSize | 8 | uimsbf |
| description; | descriptionStringSize*8 | String |
| deviceId; | 8 | uimsbf |
| gain; | 32 | decimal |
| channel_group_flag | 1 | bool |
| if (channel_group_flag == 1) { | | |
| channel_group_id; | 8 | uimsbf |
| mixingWeight; | 32 | decimal |
| metadata_info_flag | 1 | bool |
| } | | |
| If ( (channel_group_flag==0) \|\| | | |
| (metadata_info_flag == 1) ) { | | |
| optionalMetadataMask; | 3 | uimsbf |
| if ( (optionalMetadataMask & 0x01) != 0) { | | |
| bodyPartMask; | 32 | uimsbf |
| } | | |
| if ( (optionalMetadataMask & 0x02) != 0) { | | |
| trackResolution.X | 8 | ilsbf |
| trackResolution.Y | 8 | Ilsbf |
| trackResolution.Z | 8 | ilsbf |
| body PartTargetCount | 8 | uilsbf |
| for (i = 0; i <bodyPartTargetCount; i++) { | | |
| bodyPartTarget[i] | 8 | uilsbf |
| } | | |
| actuatorTargetCount | 8 | uilsbf |
| for (i = 0; i <actuatorTargetCount; i++) { | | |
| actuatorTarget[i].X | 8 | ilsbf |
| actuatorTarget[i].Y | 8 | ilsbf |
| actuatorTarget[i].Z | 8 | ilsbf |
| } | | |
| } | | |
| if ( (optionalMetadataMask & 0x04) !=0) { | | |
| direction.X | 8 | decimal |
| direction.Y | 8 | decimal |
| direction.Z | 8 | decimal |
| } | | |
| verticeCount; | 16 | uimsbf |
| for (i = 0; i <verticeCount; i++) { | | |
| Vertex | 32 | uimsbf |
| } | | |
| } | | |
| frequencySampling; | 32 | uimsbf |
| if (frequencySampling> 0) | | |
| sampleCount; | 32 | uimsbf |
| } | | |
| bandCount; | 16 | uimsbf |
| for (i = 0; i <bandCount; i++) { | | |
| MPEG_haptics_band ( ) | | |
| } | | |
| } | | |

In the syntax and semantic content of the data structure shown in Table 2, values and meanings of the fields channel_group_flag and the channel_group_id correspond to corresponding fields in the interchange-format file.

When a value of metadata_info_flag is 1, it indicates that responding metadata information is indicated; or when a value of metadata_info_flag is 0, it indicates that corresponding metadata information is not indicated. In a plurality of channels having the same channel group identifier, for a channel with a smallest channel identifier, the value of the field needs to be 1; and for the remaining channels, the value of the field needs to be 0.

Other fields involved in Table 2 have the same value and meaning as a corresponding field in the interchange-format file, and details are not described herein again.

In an embodiment of this disclosure, a method for obtaining a haptic media bitstream may include: obtaining a haptic media transport stream, the haptic media transport stream including parsing channel metadata configured for parsing a data packet, and the parsing channel metadata including a field related to a channel group, and at least including the channel group flag field; and decapsulating the haptic media transport stream, to obtain the haptic media bitstream.

In an embodiment of this disclosure, the parsing channel metadata further includes a field configured for indicating whether the haptic channel includes information related to the rendering device or the rendered part.

In this embodiment of this disclosure, a binary bitstream is further packaged as a haptic media transport stream suitable for transmission. In the haptic media transport stream, different types of data are organized as different types of data packets, and during decoding, a decoder correspondingly parses a data packet based on a type of the data packet.

In an application scenario of this embodiment of this disclosure, readMetadataChannel ( ) is configured for representing a data structure related to the parsing channel metadata. Syntactic and semantic content included in the data structure is shown in Table 3 below.

TABLE 3

| Syntax | Quantity of bits | Description |
|---|---|---|
| readMetadataChannel ( ) | | |
| { | | |
| id; | 8 | uimsbf |
| perceptionId; | 8 | uimsbf |
| descriptionLength; | 8 | uimsbf |
| description; | descriptionLength* | string |
| | 8 | |
| deviceId; | 8 | uimsbf |
| gain; | 32 | decimal |
| channel_group_flag | 1 | bool |
| if (channel_group_flag == 1) { | | |
| channel_group_id; | 8 | uimsbf |
| mixingWeight; | 32 | decimal |
| metadata_info_flag | 1 | bool |
| } | | |
| If ( (channel_group_flag==0) \|\| (metadata_info_flag==1) ) | | |
| { | | |
| optionalMetadataMask; | 8 | uimsbf |

if ( (optionalMetadataMask & 0x01) != 0) {

| | | |
|---|---|---|
| bodyPartMask; | 32 | uimsbf |
| } | | |
| if ( (optionalMetadataMask & 0x02) != 0) { | | |
| trackResolution.X; | 8 | imsbf |
| trackResolution.Y; | 8 | imsbf |
| trackResolution.Z; | 8 | imsbf |
| bodyPartTargetCount; | 8 | uimsbf |
| for (i = 0; i < bodyPartTargetCount; i++) { | | |
| bodyPartTarget; | 8 | uimsbf |
| } | | |
| actuatorTargetCount; | 8 | uimsbf |
| for (i = 0; I < actuatorTargetCount; i++) { | | |
| actuatorTarget.X | 8 | imsbf |
| actuatorTarget.Y | 8 | imsbf |
| actuatorTarget.Z | 8 | imsbf |
| } | | |
| } | | |
| if ( (optionalMetadataMask & 0x04) != 0) { | | |
| direction.X; | 8 | decimal |
| direction.Y; | 8 | decimal |
| direction.Z; | 8 | decimal |
| } | | |
| verticesCount; | 16 | uimsbf |
| for (i = 0; i < verticesCount; i++) { | | |
| vertex; | 32 | uimsbf |
| } | | |
| } | | |
| frequencySampling; | 32 | uimsbf |
| if (frequency Sampling > 0) { | | |
| sampleCount; | 32 | uimsbf |
| } | | |
| bandCount; | 16 | uimsbf |
| } | | |

In the syntactic and semantic content of the data structure shown in Table 3, each field has the same value and meaning as a corresponding field in the interchange-format file and the haptic media bitstream, and details are not described herein again.

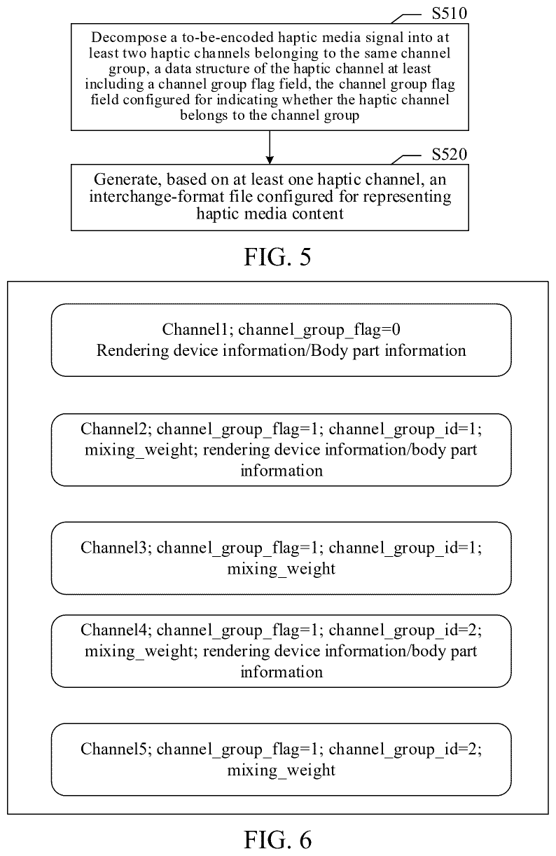

FIG. 5 is a flowchart of a haptic media processing method on an encoder side according to an embodiment of this disclosure. The haptic media processing method may be performed by the client or the server shown in FIG. 2. This embodiment of this disclosure is described by using an example in which the method is performed by the server. As shown in FIG. 5, the haptic media processing method may include the following operations S510 and S520.

S510: Decompose a to-be-encoded haptic media signal into at least two haptic channels belonging to the same channel group, a data structure of the haptic channel at least including a channel group flag field, and the channel group flag field being configured for indicating whether the haptic channel belongs to the channel group. In an example, a to-be-encoded haptic media signal is decomposed into at least two haptic channels belonging to a same channel group. A data structure of the haptic channel includes a channel group flag. The channel group flag indicates whether the haptic channel belongs to the channel group.

S520: Generate, based on at least one of the haptic channels, an interchange-format file configured for representing haptic media content. In an example, based on at least one of the haptic channels, an interchange-format file of haptic media content is generated.

In an embodiment of this disclosure, after the generating, based on at least one of the haptic channels, an interchange-format file configured for representing haptic media content, the method may further include: encoding the interchange-format file, to obtain a haptic media bitstream. The haptic media bitstream may be, for example, a binary bitstream. MPEG_haptics_channel shown in Table 2 is configured for representing a data structure representing channel metadata in the binary bitstream.

In an embodiment of this disclosure, the haptic channel metadata further includes a metadata information flag field metadata_info_flag, where the field is configured for indicating whether the haptic channel includes metadata information related to a rendering device or a rendered part.

In some implementations, one channel group includes a plurality of haptic channels, where one haptic channel (e.g., a haptic channel of a basic type) may include the metadata information related to the rendering device or the rendered part, and another haptic channel (e.g., a haptic channel of a non-basic type) does not need to repeatedly indicate the related metadata information, so that data redundancy can be reduced, and data processing efficiency can be improved.

In an embodiment of this disclosure, after the haptic media bitstream is obtained, the haptic media bitstream may be further encapsulated to obtain a haptic media transport stream. The haptic media transport stream includes parsing channel metadata configured for parsing a data packet, the parsing channel metadata including a field related to a channel group.

In an embodiment of this disclosure, the parsing channel metadata further includes a field configured for indicating whether the haptic channel includes the information related to the rendering device or the rendered part.

For specific implementations of the data structure of the haptic channel and operations in this embodiment of this disclosure, refer to the embodiments corresponding to the decoder side described above, and details are not described herein again.

FIG. 6 is a schematic diagram of data structures of a plurality of haptic channels represented based on a channel group in an application scenario according to an embodiment of this disclosure.

As shown in FIG. 6, under the perception (referring to FIG. 4), the plurality of haptic channels, namely, channel1 to channel5, are included. In the haptic channel channel1, a value of a channel group flag field channel_group_flag is 0, it indicates that the haptic channel is an independent haptic channel and does not belong to any channel group.

In the haptic channels channel2 and channel3, the value of the channel group flag field channel group_flag is 1, and a value of a channel group identifier field channel_group_id is 1, it indicates that the haptic channels channel2 and channel3 belong to the same channel group, and an identifier of the channel group is 1.

In the haptic channels channel4 and channel5, the value of the channel group flag field channel_group_flag is 1, and the value of the channel group identifier field channel_group_id is 2, it indicates that the haptic channels channel2 and channel3 belong to the same channel group, and an identifier of the channel group is 2.

Based on the data structures of the plurality of haptic channels shown in FIG. 6, a haptic media processing method performed by a server end and a client may include the following processes.

(1) The server produces or acquires a haptic media signal based on an expected haptic media effect, and generates an interchange-format file of the haptic media signal.

Haptic media signals of different haptic types are represented as different perceptions. It is assumed that there is only one perception, and a haptic type of the perception is vibration.

The haptic media signals of the perceptual type are represented as different haptic channels based on different sensors or different rendering devices on which the haptic media signals are finally presented.

For example, media signals presented on the same rendering device are represented as N different haptic channels. In this case, the N different haptic channels need to be mixed into one signal and then presented. For example, channel1 is an independent channel, channel2 and channel3 are a channel group, and channel4 and channel5 are a channel group.

Based on forming of a channel group, metadata related to rendering and representation of the N haptic channels is indicated. In this case, related metadata such as information about the rendering device and the information about the body part is indicated only in channel1, channel2, and channel4.

A signal of a single haptic channel is further decomposed into a band, a haptic effect, and a key frame, as shown in FIG. 4.

(2) The server compresses the haptic media signal into a haptic media bitstream.

(3) After packaging and encapsulating the haptic media bitstream, the server forms a haptic media transport stream convenient for transmission.

(4) After decapsulating the received haptic media transport stream, the client obtains the haptic media bitstream.

(5) After decoding the haptic media bitstream, the client obtains an interchange-format file of the haptic media signal.

(6) Based on metadata of haptic channels in the interchange-format file, the client decodes, renders, and presents each haptic channel.

Channel1 is decoded and presented according to metadata possessed by channel1.

After channel2 and channel3 are mixed, decoding and presentation are performed based on metadata indicated in channel2.

After channel4 and channel5 are mixed, decoding and presentation are performed based on metadata indicated in channel4.

It can be known based on descriptions of the foregoing application scenarios that, the haptic media content representation method provided in the embodiments of this disclosure may be configured for flexibly representing a haptic media signal, and supporting storage and transmission of a binary bitstream of haptic media based on the representation of the haptic media signal. According to the method, a combination of a plurality of groups of haptic channels can be supported to be defined, and when there is a channel group, a problem of repeated indication of metadata can be avoided based on a shared metadata manner.

Although the steps of the method in this disclosure are described in a specific sequence in the accompanying drawings, this does not require or imply that these steps have to be executed according to the specific sequence, or all the steps shown have to be performed to achieve an expected result. Additionally or alternatively, some steps may be omitted, a plurality of steps may be combined into one step, and/or one step may be decomposed into a plurality of steps for execution, and the like.

The following describes an apparatus embodiment of this disclosure, which may be used to perform the haptic media processing method in the foregoing embodiment of this disclosure.

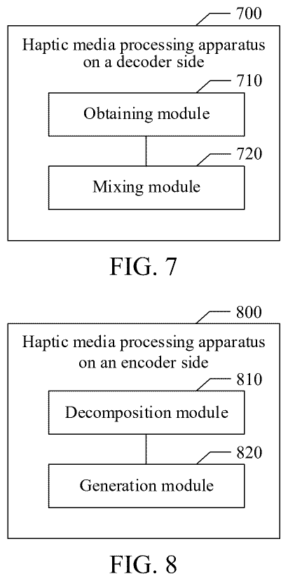

FIG. 7 is a schematic structural block diagram of a haptic media processing apparatus on a decoder side according to an embodiment of this disclosure. As shown in FIG. 7, the haptic media processing apparatus 700 on the decoder side may include an obtaining module 710 and a mixing module 720.

The obtaining module 710 is configured to obtain an interchange-format file configured for representing haptic media content, the interchange-format file including at least one haptic channel, a data structure of the haptic channel at least including a channel group flag field, and the channel group flag field being configured for indicating whether the haptic channel belongs to a channel group.

The mixing module 720 is configured to, when the channel group flag field indicates that at least two haptic channels belong to the channel group, mix all haptic channels in the channel group, to obtain a to-be-rendered haptic media signal.

FIG. 8 is a schematic structural block diagram of a haptic media processing apparatus on an encoder side according to an embodiment of this disclosure. As shown in FIG. 8, the haptic media processing apparatus 800 on the encoder side may include a decomposition module 810 and a generation module 820.

The decomposition module 810 is configured to decompose a to-be-encoded haptic media signal into at least two haptic channels belonging to the same channel group, a data structure of the haptic channel at least including a channel group flag field, and the channel group flag field being configured for indicating whether the haptic channel belongs to the channel group.

The generation module 820 is configured to generate, based on at least one of the haptic channels, an interchange-format file configured for representing haptic media content.

Specific details of the haptic media processing apparatus provided in the embodiments of this disclosure are described in detail in corresponding method embodiments, and details are not described herein again.

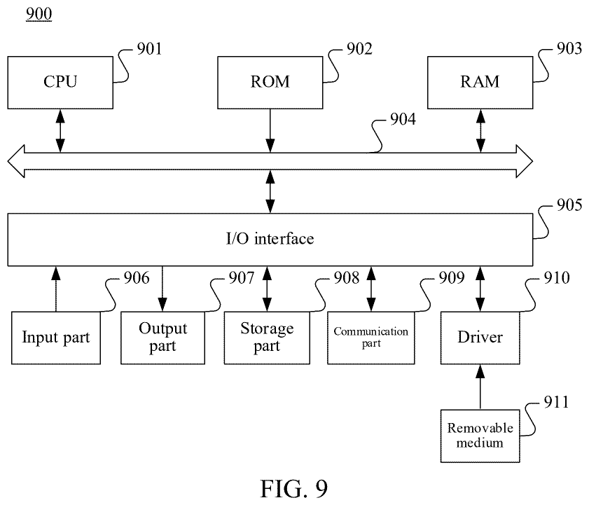

FIG. 9 schematically illustrates a structure block diagram of a computer system used to implement an electronic device according to an embodiment of this disclosure.

A computer system 900 of the electronic device shown in FIG. 9 is merely an example, and does not bring any limitation to the function and use scope of the embodiments of this disclosure.

As shown in FIG. 9, the computer system 900 includes processing circuitry, such as a central processing unit (CPU) 901, and the CPU 901 may perform various appropriate actions and processing according to a program stored in a read-only memory (ROM) 902 or a program loaded from a storage part 908 to a random access memory (RAM) 903. The RAM 903 further stores various programs and data required by system operations. The CPU 901, the ROM 902, and the RAM 903 are connected to each other by using a bus 904. An input/output interface 905 (I/O interface) is also connected to the bus 904.

The following components are connected to the input/output interface 905: an input part 906 including a keyboard, a mouse, and the like; an output part 907, including a cathode ray tube (CRT), a liquid crystal display (LCD), a speaker, and the like; a storage part 908 including a hard disk and the like; and a communication part 909 including a network interface card such as a local area network card and a modem. The communication part 909 performs communication processing by using a network such as the Internet. A driver 910 is also connected to the input/output interface 905 as required. A removable medium 911, such as a magnetic disk, an optical disc, a magneto-optical disk, or a semiconductor memory, is installed on the driver 910 as required, so that a computer program read from the removable medium 911 is installed into the storage part 908 as required.

Particularly, according to an embodiment of this disclosure, the processes described in the method flowcharts may be implemented as computer software programs. For example, an embodiment of this disclosure includes a computer program product, the computer program product includes a computer program carried on a computer-readable medium, and the computer program includes program code configured for performing the methods shown in the flowcharts. In such an embodiment, the computer program may be downloaded and installed from a network by using the communication part 909, and/or installed from the removable medium 911. When the computer program is executed by the CPU 901, various functions defined in the system of this disclosure are performed.

The computer-readable medium shown in the embodiments of this disclosure may be a computer-readable signal medium or a computer-readable storage medium, such as a non-transitory computer-readable storage medium, or any combination thereof. The computer-readable storage medium may be, for example, but is not limited to, an electrical, magnetic, optical, electromagnetic, infrared, or semiconductor system, apparatus, or device, or any combination thereof. More specific examples of the computer-readable storage medium may include but are not limited to: an electrical connection with at least one wire, a portable computer disk, a hard disk, a random access memory (RAM), a read-only memory (ROM), an erasable programmable read-only memory (EPROM), a flash memory, an optical fiber, a portable compact disc read-only memory (CD-ROM), an optical memory device, a magnetic memory device, or any appropriate combination thereof. In this disclosure, the computer-readable storage medium may be any tangible medium containing or storing a program, where the program may be used by or used in combination with an instruction execution system, an apparatus, or a device. In this disclosure, a computer-readable signal medium may include a data signal being in a baseband or propagated as a part of a carrier wave, the data signal carrying computer-readable program code. A data signal propagated in such a way may assume a plurality of forms, including but not limited to, an electromagnetic signal, an optical signal, or any appropriate combination thereof. The computer-readable signal medium may further be any computer-readable medium in addition to a computer-readable storage medium. The computer-readable medium may send, propagate, or transmit a program that is used by or used in combination with an instruction execution system, an apparatus, or a device. The program code included in the computer-readable medium may be transmitted by using any appropriate medium, including but not limited to: wireless medium, wired medium, or the like, or any appropriate combination thereof.

The flowcharts and block diagrams in the accompanying drawings show architectures, functions, and operations that may be implemented by the system, the method, and the computer program product according to the embodiments of this disclosure. In this regard, each block in a flowchart or a block diagram may represent a module, a program segment, or a part of code, and the foregoing module, program segment, or part of code includes at least one executable instruction configured for implementing a specified logical function. In some implementations used as substitutes, functions annotated in blocks may alternatively occur in a sequence different from that annotated in the accompanying drawings. For example, actually two blocks shown in succession may be performed basically in parallel, and sometimes the two blocks may alternatively be performed in a reverse sequence. This is determined by a related function. Each block in the block diagram or the flowchart, and a combination of blocks in the block diagram or the flowchart may be implemented by using a dedicated hardware-based system that performs a specified function or operation, or may be implemented by using a combination of dedicated hardware and computer instructions.

Although a plurality of modules or units of a device configured to perform actions are described in the foregoing detailed descriptions, such a division is not mandatory. According to the implementations of this disclosure, the features and functions of two or more modules or units described above may be specifically implemented in one module or unit. Conversely, features and functions of the module or unit described above may be further divided into a plurality of modules or units for implementation.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Through the descriptions of the foregoing implementations, a person skilled in the art easily understands that the example implementations described herein may be implemented through software, or may be implemented through software located in combination with necessary hardware. Therefore, the technical solutions of the implementations of this disclosure may be implemented in a form of a software product. The software product may be stored in a non-volatile storage medium (which may be a CD-ROM, a USB flash drive, a removable hard disk, or the like) or on the network, including several instructions for instructing a computing device (which may be a personal computer, a server, a touch terminal, a network device, or the like) to perform the methods according to the embodiments of this disclosure.

After considering the specification and practicing the present disclosure, a person skilled in the art would recognize other implementations of this disclosure. This disclosure is intended to cover any variation, use, or adaptive change of this disclosure.

This disclosure is not limited to the precise structures described above and shown in the accompanying drawings, and various modifications and changes can be made without departing from the scope of this disclosure.

What is claimed is:

1. A haptic media processing method, comprising:
obtaining an interchange-format file of haptic media content, the interchange-format file including a data structure of a haptic channel, the data structure of the haptic channel including a channel group flag, and the channel group flag indicating whether the haptic channel belongs to a channel group; and
when the channel group flag indicates that at least two haptic channels belong to the channel group, mixing, by processing circuitry, the haptic channels in the channel group, to obtain a haptic media signal.

2. The haptic media processing method according to claim 1, wherein when the haptic channel belongs to the channel group, the data structure of the haptic channel further comprises:
channel group identification information indicating an identifier of the channel group to which the haptic channel belongs.

3. The haptic media processing method according to claim 1, wherein the channel group flag indicates an identifier of the channel group when the haptic channel belongs to the channel group.

4. The haptic media processing method according to claim 3, wherein
a value of the channel group flag being a first value indicates the haptic channel does not belong to any channel group;
the value of the channel group flag being a second value indicates the haptic channel belongs to a channel group; and
when the value of the channel group flag is the second value, the identifier of the channel group is determined based on the second value.

5. The haptic media processing method according to claim 1, wherein when the haptic channel belongs to the channel group, the data structure of the haptic channel further comprises:
mixing weight information indicating a weight used when all the haptic channels in the channel group are mixed to obtain the haptic media signal.

6. The haptic media processing method according to claim 1, wherein when the haptic channel does not belong to any channel group, the data structure of the haptic channel further comprises:
body part mask information indicating a body part rendered based on the haptic channel.

7. The haptic media processing method according to claim 1, wherein
types of haptic channels belonging to a same channel group include a basic type and a non-basic type; and
when the haptic channel is of the basic type, the data structure of the haptic channel includes metadata information related to a rendering device or a rendered part; and
when the haptic channel is of the non-basic type, the data structure of the haptic channel does not include the metadata information.

8. The haptic media processing method according to claim 7, wherein the metadata information includes body part mask information that indicates a body part rendered based on the haptic channel.

9. The haptic media processing method according to claim 7, wherein the metadata information includes at least one of:
reference device identification information indicating an identifier of the rendering device corresponding to the haptic channel;
device resolution information indicating a resolution of the rendering device corresponding to the haptic channel;
body part target information indicating a semantic descriptor of a body part or a group of body parts rendered based on the haptic channel;
device target information indicating location information of the rendering device corresponding to the haptic channel;
vertex information indicating a mesh vertex of a haptic object corresponding to the haptic channel; and
direction information indicating a haptic direction based on which a signal of the haptic channel is rendered.

10. The haptic media processing method according to claim 7, wherein the data structure of the haptic channel further comprises:
a metadata information flag indicating whether the haptic channel includes the metadata information.

11. The haptic media processing method according to claim 7, wherein
the data structure of the haptic channel includes channel identification information indicating a channel identifier of the haptic channel, and
the type of the haptic channel is determined based on a value of the channel identification information.

12. The haptic media processing method according to claim 11, wherein the basic type is a type of the haptic channel corresponding to a smallest value of the channel identification information in the channel group.

13. The haptic media processing method according to claim 1, wherein the obtaining the interchange-format file comprises:
obtaining a haptic media bitstream, the haptic media bitstream including haptic channel metadata for decoding the haptic channel, the haptic channel metadata including the channel group flag; and
decoding the haptic media bitstream to obtain the interchange-format file.

14. The haptic media processing method according to claim 13, wherein the haptic channel metadata further comprises:
a metadata information flag indicating whether the haptic channel includes metadata information related to a rendering device or a rendered part.

15. The haptic media processing method according to claim 13, wherein the obtaining the haptic media bitstream comprises:
obtaining a haptic media transport stream, the haptic media transport stream including parsing channel metadata for parsing a data packet, and the parsing channel metadata including the channel group flag; and
decapsulating the haptic media transport stream to obtain the haptic media bitstream.

16. The haptic media processing method according to claim 15, wherein the parsing channel metadata indicates whether the haptic channel includes information related to a rendering device or a rendered part.

17. A haptic media processing method, comprising:
decomposing a to-be-encoded haptic media signal into at least two haptic channels belonging to a same channel group, a data structure of the haptic channel including a channel group flag, and the channel group flag indicating whether the haptic channel belongs to the channel group; and
generating, based on at least one of the haptic channels, an interchange-format file of haptic media content.

18. A haptic media processing apparatus, comprising:
processing circuitry configured to:
obtain an interchange-format file of haptic media content, the interchange-format file including a data structure of a haptic channel, the data structure of the haptic channel including a channel group flag, and the channel group flag indicating whether the haptic channel belongs to a channel group; and
when the channel group flag indicates that at least two haptic channels belong to the channel group, mix the haptic channels in the channel group, to obtain a haptic media signal.

19. The haptic media processing apparatus according to claim 18, wherein when the haptic channel belongs to the channel group, the data structure of the haptic channel further comprises:
channel group identification information indicating an identifier of the channel group to which the haptic channel belongs.

20. The haptic media processing apparatus according to claim 18, wherein the channel group flag indicates an identifier of the channel group when the haptic channel belongs to the channel group.
